(19) United States
(12) Patent Application Publication
(10) Pub. No.: US 2023/0124458 A1
(43) Pub. Date: Apr. 20, 2023

(54) Process of Rare Earth Recovery from Ores Containing Bastnaesite

(71) Applicant: THE SASKATCHEWAN RESEARCH COUNCIL, Saskatoon (CA)

(72) Inventors: Jack Zhang, Saskatoon (CA); Baodong Zhao, Saskatoon (CA)

(21) Appl. No.: 17/800,620

(22) PCT Filed: Feb. 19, 2021
(86) PCT No.: PCT/CA2021/050184

§ 371 Date: Aug. 18, 2022

Related U.S. Application Data
(60) Provisional application No. 62/979,647, filed on Feb. 21, 2020.

(51) Int. Cl. C22B 59/00; C22B 1/06; C22B 1/24; C22B 3/04; C22B 3/44; C01F 17/247

(52) U.S. Cl. CPC C22B 59/00; C22B 1/06; C22B 1/24; C22B 3/04; C22B 3/44; C01F 17/247

(57) ABSTRACT

The present invention relates to the recovery of metals from raw ores or concentrates, and more specifically, to the recovery of rare earth elements, or oxides or salts thereof, from ores containing bastnaesite carbonatite, and/or monazite. The ore is processed by a method that may include one or more of the following steps: (i) mechanically processing the ore; (ii) calcination and/or roasting of the ore to form a calcinated material and/or roasting of the ore to form a roasted material; (iii) leaching of the calcinated material or roasted material in an aqueous solution; (iv) solid/liquid separation to remove a solid residue from the aqueous solution to recover a rare earth element solution; and (v) precipitation of the rare earth element solution to isolate a rare earth element, or oxide or salt thereof.

### BACKGROUND

### Field of Disclosure

The disclosure relates generally to the field of the recovery of metals from raw ores or concentrates, and more specifically, to the recovery of rare earth elements, or oxides or salts thereof, from ores containing bastnaesite, carbonatite, and/or monazite.

### Description of Related Art

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

Rare Earth is the name of a group of 17 individual elements, including yttrium (Y) and scandium (Sc), as well as 15 lanthanide elements: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). They are not really rare in the earth crust in comparison to base metals such as copper, nickel, lead, zinc, etc. However, rare earth elements (REEs) are often found together as a group in minerals such as bastnaesite, monazite, apatite, etc. To separate the rare earth minerals from the rock and divide the rare earth elements from each other may be difficult. Rare earth separation technology plays an important role in the rare earth mining and recovery industry.

Rare earth elements are important, as they have wide applications in many high technology areas. According to the Department of Energy of the United States, Neodymium (Nd), Dysprosium (Dy), Europium (Eu), and Terbium (Tb) are classified as critical based on their importance and low supplies. Rare earth elements have distinctive electrical, metallurgical, catalytic, nuclear, magnetic, and luminescent properties and are important for many advanced technologies, including consumer electronics, computers and networks, communications, clean energy, advanced transportation, health care, environmental mitigation, national defense etc. Usage ranges from daily use (e.g., lighter flints, glass polishing mediums, car alternators) to high-end technology (lasers, magnets, batteries, fibre-optic telecommunication cables).

Rare earth elements may be mined from the earth's crust as ore deposits and may be recovered through stages of physical and chemical separation processes. The physical separation process typically includes crushing, grinding, gravity separation, magnetic separation, electrostatic separation, sensor-based sorting such as X-ray sorting, and/or flotation. The chemical separation process may include calcination, roasting, leaching, fractional precipitation, ion exchange, and solvent extraction. The physical and chemical processes are often drastically different due to the unique characteristics of each ore deposit. Rare earth orebodies often have complicated mineralogy that makes the recovery and separation processes complicated, expensive, and environmentally challenging.

### SUMMARY

It is an object of the present disclosure to provide a method of processing ores, such as those containing bastnaesite, carbonatite, and/or monazite. The method of processing the ore may include one or more of the following steps:
(i) mechanically processing the ore;
(ii) calcination of the ore to form a calcinated material or roasting of the ore to form a roasted material;
(iii) leaching of the calcinated material or roasted material in an aqueous solution;
(iv) solid/liquid separation to remove a solid residue from the aqueous solution to recover a rare earth element solution; and
(v) precipitation of the rare earth element solution to isolate a rare earth element, or oxide or salt thereof.

### BRIEF DESCRIPTION OF THE DRAWINGS

These and other features, aspects and advantages of the disclosure will become apparent from the following description, appending claims and the accompanying drawings, which are briefly described below.

FIG. 1 is a flow diagram of a process according to a disclosed embodiment.

FIG. 2 is a flow diagram of a process according to a disclosed embodiment.

FIG. 3 is a flow diagram of a process according to a disclosed embodiment.

FIG. 4 is a flow diagram of a process according to a disclosed embodiment.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

At the outset, for ease of reference, certain terms used in this application and their meaning as used in this context are set forth below. To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Throughout this disclosure, where a range is used, any number between or inclusive of the range is implied.

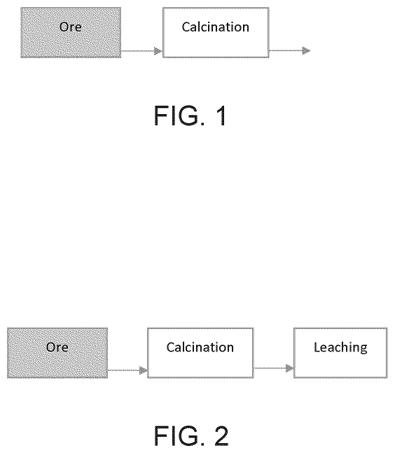

Generally, the present disclosure provides a method of processing ores containing bastnaesite, carbonatite, and/or monazite. FIG. 1 is a flow diagram of a process according to a disclosed embodiment. FIG. 1 shows a method of processing an ore containing bastnaesite, carbonatite, and/or monazite, the process comprising providing the ore bastnaesite, and calcination of the ore to form a calcinated material. The method of processing an ore containing bastnaesite, carbonatite, and/or monazite may be for an ore having a particle size of less than 10 mm. The ore may be of any suitable particle size. The ore may have a particle size of less than 5 mm, less than 2 mm, or less than 1 mm. The ore containing bastnaesite, carbonatite, and/or monazite may have been previously mechanically processed to achieve a particle size of the ore of less than 10 mm, less than 5 mm, less than 2 mm, or less than 1 mm.

As used herein, the term “mechanically processed” may include any suitable mechanical manipulation of the ore. The mechanical processing may be for the purpose of breaking the ore into smaller particles to facilitate the remaining processing. The mechanical processing may include mechanical manipulation such as crushing, grinding, gravity separation, magnetic separation, electrostatic separation, sensor based sorting, and/or flotation. In some embodiments, mechanical processing may include crushing and/or grinding. The ore containing bastnaesite, carbonatite, and/or monazite may be mechanically processed to achieve a particle size of less than 10 mm, less than 5 mm, less than 2 mm, or less than 1 mm. The ore containing bastnaesite, carbonatite, and/or monazite may be screened to one or more size fractions, such as three fractions including 0.5 to 2 mm, 0.15 to 0.5 mm, and less than 0.15 mm.

The step of calcination of the ore containing bastnaesite, carbonatite, and/or monazite is to form a calcinated material. Calcination may be done in the presence or absence of a reagent. Calcination may be done in the presence of lime or soda ash, or combinations thereof. The calcination step may be done at any suitable temperature. The calcination step may be done at a temperature of about 250° C. to about 750° C. The calcination step may be done at a temperature of about 500° C. to about 700° C., about 600° C. to about 700° C., about 600° C. to about 750° C., about 500° C. to about 600° C., about 550° C. to about 650° C., about 550° C. to about 750° C., about 450° C. to about 500° C., about 500° C. to about 550° C., about 550° C. to about 600° C., about 600° C. to about 650° C., about 650° C. to about 700° C., about 700° C. to about 750° C., about 450° C. to about 750° C., about 400° C. to about 700° C., about 400° C. to about 750° C., about 300° C. to about 700° C., about 300° C. to about 750° C., or about 250° C. to about 700° C. The calcination step may be done at a temperature of about 250° C., about 300° C., about 350° C., about 400° C., about 450° C., about 500° C., about 550° C., about 600° C., about 650° C., about 700° C., or about 750° C. The calcination step may be done for any suitable amount of time. The calcination step may be done for about 0.25 to about 10 hours. The calcination step may be done for about 0.25 hours to about 0.5 hours, about 0.25 hours to about 0.75 hours, about 0.25 hours to about 1 hour, about 0.5 hours to about 1 hour, about 1 hour to about 2 hours, about 0.5 hours to about 2 hours, about 0.25 hours to about 2 hours, about 0.75 hours to about 2 hours, about 1 hour to about 3 hours, about 1 hour to about 4 hours, about 1 hour to about 5 hours, about 1 hour to about 6 hours, about 1 hour to about 8 hours, about 1 hour to about 10 hours, about 1.5 hours to about 2 hours, about 2 hours to about 3 hours, about 2 hours to about 4 hours, about 2 hours to about 6 hours, about 2 hours to about 8 hours, about 2 hours to about 10 hours, about 3 hours to about 4 hours, about 3 hours to about 5 hours, about 3 hours to about 6 hours, about 3 hours to about 8 hours, about 3 hours to about 10 hours, about 4 hours to about 6 hours, about 4 hours to about 8 hours, about 4 hours to about 10 hours, about 5 hours to about 7 hours, about 5 hours to about 10 hours, about 6 hours to about 8 hours, about 6 hours to about 10 hours, about 7 hours to about 10 hours, about 8 hours to about 10 hours, about 9 hours to about 10 hours. The calcination step may be done for more than 10 hours. The calcination step may be done for about 0.25 hours, about 0.5 hours, about 0.75 hours, about 1 hour, about 2 hours, about 3 hours, about 4 hours, about 5 hours, about 6 hours, about 7 hours, about 8 hours, about 9 hours, or about 10 hours. The calcination step may be done for more than 10 hours. The calcination step may be done at atmospheric pressure. The calcination step may be done at a temperature of about 250° C. to about 750° C. for about 0.25 to about 10 hours at atmospheric pressure. The calcination step may be done at temperatures higher than 400° C. The calcination step may be done in the presence of other suitable reagents, such as acids. The purpose of the calcination step is to make the rare earth elements soluble in order to extract them in a further processing step. Any suitable conditions may be used to make the rare earth elements soluble, in order to extract them in a further processing step. It should be understood that the particular conditions for calcination can be modified without departing from the scope of the present invention.

The method of processing an ore containing bastnaesite, carbonatite, and/or monazite may involve roasting. Roasting may be done in addition to calcination. Roasting may be done instead of calcination. The ore may be roasted at a temperature of about 120° C. to about 500° C. with acids, such as H₂SO₄, to make the rare earth elements soluble in order to extract them in a further processing step. The roasting may be done at a temperature of about 200° C. to about 300° C., about 200° C. to about 250° C., about 250° C. to about 300° C., about 175° C. to about 300° C., about 150° C. to about 300° C., about 125° C. to about 300° C., about 200° C. to about 350° C., about 250° C. to about 350° C., about 150° C. to about 250° C., about 150° C. to about 350° C., about 200° C. to about 400° C., about 150° C. to about 400° C., about 200° C. to about 500° C., about 250° C. to about 400° C., about 250° C. to about 500° C., about 300° C. to about 400° C., about 300° C. to about 500° C., about 400° C. to about 500° C. The roasting may be done at a temperature of about 120° C., about 150° C., about 200° C., about 250° C., about 300° C., about 350° C., about 400° C., about 450° C., or about 500° C. The roasting may be done for any suitable amount of time, such as for about 1 hour, about 2 hours, or about 3 hours. The roasting may be done at atmospheric pressure. The specific process parameters may vary from one embodiment to another. The optimal calcination parameters for a particular bastnaesite ore may be determined through a series of tests.

The method of processing ores containing bastnaesite, carbonatite, and/or monazite may further include a leaching step. The leaching step may include leaching of the calcinated material in an aqueous solution to dissolve a rare earth element, or oxide or salt thereof, from the calcinated bastnaesite material in the aqueous solution. The aqueous solution may be water. The aqueous solution may comprise H₂SO₄, HCl, HNO₃, or combinations thereof. The leaching step may be done at any suitable temperature, such as about 70° C., about 80° C., or about 90° C. The leaching step may be done at any suitable pH, such as about pH 2.0, about pH 2.5, or about pH 3.0. The leaching step may be done for any suitable amount of time, such as for about 1 hour, about 2 hours, about 3 hours, about 4 hours, or about 5 hours. The leaching step may be done at atmospheric pressure. The specific process parameters, such as leaching temperature, retention time, pulp density, etc. may vary from one embodiment to another. The optimal leaching parameters for a particular ore containing bastnaesite, carbonatite, and/or monazite may be determined through a series of tests.

The method of processing ores containing bastnaesite, carbonatite, and/or monazite may include both calcination and leaching, as outlined in FIG. 2. The method of processing the ore containing bastnaesite, carbonatite, and/or monazite may include calcination and/or leaching, together with additional processing steps. The method of processing ores containing bastnaesite, carbonatite, and/or monazite may include separation and/or precipitation steps.

The method of processing ore containing bastnaesite, carbonatite, and/or monazite may include a separation step following the leaching step. The separation step may involve a solid/liquid separation to remove a solid residue from the leaching solution. The separation step may involve a solid/liquid separation to remove a solid residue from the aqueous solution used in the leaching step. The separation step may be to recover a rare earth element solution. The solid/liquid separation step following leaching may be used to remove the residue and recover the solution that contains the majority of the rare earth elements, or oxides or salts thereof. The residue may be for disposal. The residue may be used to recover by-products. The residue may be used for other purposes.

The method of processing an ore containing bastnaesite, carbonatite, and/or monazite may include a precipitation step. The precipitation step may occur after the leaching step. The precipitation step may occur after the separation step. The precipitation step may include precipitation of a rare earth element, or oxide or salt thereof, from a rare earth element solution. The rare earth element solution may be obtained from a previous leaching or separation step. The precipitation step may include precipitation of the rare earth element solution obtained from the solid/liquid separation step, to isolate a rare earth element, or oxide or salt thereof. The precipitation step may be in the presence of oxalic acid or a double salt, such as sodium double sulphate. The precipitation step may be in the presence of ammonium bicarbonate. The precipitation step may be done at any suitable temperature, such as about 50 to about 60° C. The precipitation step may be done at any suitable feed concentration, such as about 0.5 to about 1.0 M. Precipitation in the presence of oxalic acid or a double salt may be considered a direct precipitation method. The precipitation step may involve an indirect precipitation after impurity removal. The precipitation step may involve impurity removal in the presence of a reagent, prior to precipitation of the rare earth element, or oxide or salt thereof. The precipitation may involve impurity removal in the presence of a reagent such as lime, carbonate, or other alkalis. The precipitated rare earth element, or oxide or salt thereof, may include mixed rare earth oxides or carbonates. The optimal process configuration, such as stages, may vary from one embodiment to another. The optimal precipitation parameters, such as reagent dosages, temperature, time, etc. may vary from one embodiment to another. The optimal precipitation conditions for a particular ore containing bastnaesite, carbonatite, and/or monazite, or for a particular rare earth element solution, may be determined through a series of tests.

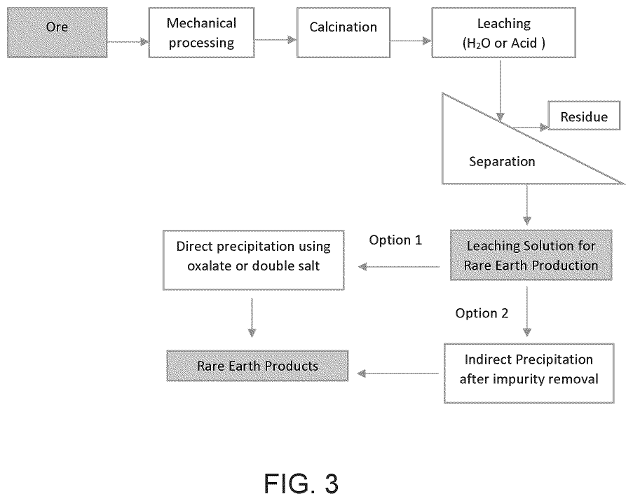

One embodiment of a method of processing ore containing bastnaesite, carbonatite, and/or monazite is shown in FIG. 3. The process of FIG. 3 involves mechanical processing of the ore, followed by a calcination step, a leaching step, and a separation step to give a residue and a leaching solution for rare earth production (i.e. a rare earth element solution). The leaching solution for rare earth production can be processed by one of two methods, option 1 being direct precipitation and option 2 being indirect precipitation after impurity removal. Either precipitation method gives rare earth products comprising a rare earth element, or an oxide or salt thereof.

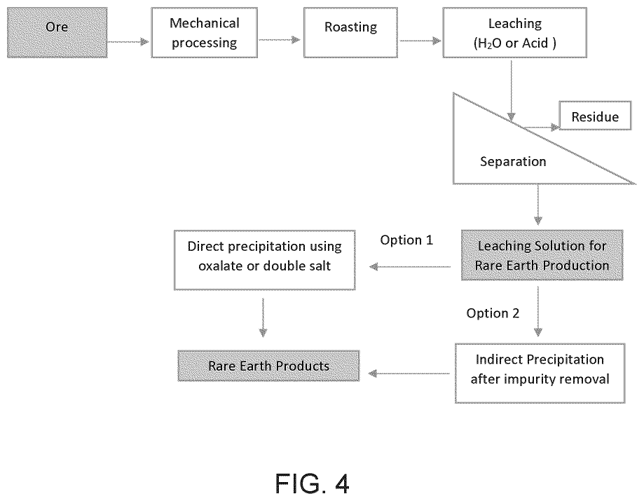

One embodiment of a method of processing ore containing bastnaesite, carbonatite, and/or monazite is shown in FIG. 4. The process of FIG. 4 involves mechanical processing of the ore, followed by a roasting step, a leaching step, and a separation step to give a residue and a leaching solution for rare earth production (i.e. a rare earth element solution). The leaching solution for rare earth production can be processed by one of two methods, option 1 being direct precipitation and option 2 being indirect precipitation after impurity removal. Either precipitation method gives rare earth products comprising a rare earth element, or an oxide or salt thereof.

The method of processing ore containing bastnaesite, carbonatite, and/or monazite according to embodiments of the present invention provides a rare earth product. The rare earth product comprises a rare earth element, or an oxide or salt thereof. The rare earth product or rare earth element may include mixed rare earth oxides or carbonates. The rare earth element may be scandium, yttrium, lanthanum, cerium, praseodymium, neodymium, samarium, europium, gadolinium, terbium, dysprosium, holmium, erbium, thulium, ytterbium, or lutetium, or oxides or salts thereof, or combinations thereof.

The method of processing ore containing bastnaesite, carbonatite, and/or monazite may involve the production of wastewater as a by-product. Wastewater and tailing may be treated prior to disposal.

The method of processing ore containing bastnaesite, carbonatite, and/or monazite may also be used to treat other rare earth minerals, or other materials containing rare earth elements.

### EXAMPLES

### Example 1: Monazite Concentrate Process

Monazite concentrate with a high REE (rare earth elements) grade (55% to 60% REO) and low impurities may be used for this process, to simplify downstream processes. Monazite concentrate processes may include caustic cracking, hydrochloric acid (HCl) selective leaching, purification of the REE (rare earth elements) pregnant leach solution (PLS), mixed REE carbonate precipitation, as well as the recovery of phosphate by-product as Tri-Sodium Phosphate (TSP, Na₃PO₄.12H₂O).

Caustic cracking: As a product of the caustic cracking, REE hydroxides may adhere to the surface of the concentrate particles and create a barrier to further reaction. Therefore, fine grinding and aggressive agitation improve reaction kinetics and help to promote the cracking. For example, the concentrate may undergo grinding to 100% passing 325 mesh (P100=43 μm). Caustic cracking decomposes the monazite and converts the REE phosphate to REE hydroxides. More than 97% of the REE phosphate can be converted to REE hydroxide (dependent on the xenotime content in the monazite concentrate), with the caustic consumption of 641 kg/t monazite concentrate using the caustic conditions that follow: feed grinding: P100=43 μm; monazite concentrate to caustic soda ratio: 1:1.5; caustic soda concentration: 50%; temperature: 140° C.; and residence time: 5 hr.

Hydrochloric acid selective leaching: REE selective leaching with HCl dissolves the REEs and removes impurities through pH control to realize the initial separation of REEs from Th, U, and Fe. The REE recovery is more than 85% (dependent on the xenotime content in the monazite concentrate), with 36% HCl consumption of 906 kg/t monazite concentrate at the conditions that follow: pulp density: 40% solids; temperature: 70° C.; leaching at pH 2.5 for 0.5 hr; re-precipitation at pH 4.5 for 1.0 hr.

Pregnant leach solution (PLS) purification: In this example, impurities, including Fe, Al, Ca, Mg, Ba, Pb and Zn in the PLS, are very low and no further impurity removal process is needed. Therefore, only Radium (Ra) removal is necessary. More than 99% of Ra228 and Ra226 can be removed by using a BaSO₄ co-precipitation method, with BaCl₂ and H₂SO₄ (98%) consumption of 2.4 and 3.4 kg/t monazite concentrate, respectively. The REE loss in this process is 0.6%.

Mixed REE carbonate precipitation: The mixed REE carbonate product of this example meets the product specifications with REE recovery of 95% at the following conditions: feed PLS concentration: 0.5 mol/L to 1.0 mol/L (80 to 160 g/L REO); precipitation temperature: 50 to 60° C.; ammonium bicarbonate concentration: 15% (saturated); precipitation duration: until no bubbles; ammonium bicarbonate consumption: 694 kg/t monazite concentrate or 1524 kg/t REO.

Phosphate recovery as tri-sodium phosphate (TSP): The combined filtrate and washes from the caustic cracking step of this example contains soluble TSP and unconsumed caustic soda (NaOH). Raw TSP can be crystallized and recovered by heating and evaporating the liquid until the temperature reaches 135° C., followed by filtration after cooling to about 40° C. The raw TSP is purified with uranium removal and TSP recrystallization processes. The final TSP product meets the typical commercial specifications. The mother liquor from the raw TSP crystallization contains about 40% NaOH and is recycled to the caustic cracking process.

Example 1, overall: The REE recovery is more than 85% and the TSP recovery is 98%. For example, a 300 g sample of monazite concentrate with a grade of 60.3% REO was processed at the conditions outlined above for Example 1. 86.2% of REE was recovered into the PLS with very low level impurities that meet the specifications for mixed REE carbonate precipitation after radium removal.

### Example 2: Bastnaesite Ore Process

The REE grade bastnaesite concentrate for industry processing is around 70% REO, which is produced by flotation after grinding to 100% passing 75 μm. The processing of bastnaesite ore may include dense media separation (DMS), HCl/NaOH processing, oxidation roasting/HCl leach processing, and oxidation roasting/H₂SO₄ leach processing.

Dense media separation: In this example, the bastnaesite ore is upgraded to about 50% REO by DMS (Dense Media Separation) after crushing to <2.0 mm. Bastnaesite concentrate with 50% REO grade can be processed successfully at <2.0 mm without grinding. The benefits include cost saving in both CAPEX and OPEX without grinding or flotation. The crushed <2.0 mm bastnaesite ore sample is screened to three size fractions including 0.5-2.0 mm, 0.15-0.5 mm, and <0.15 mm. The 0.5-2.0 mm and 0.15-0.5 mm fractions are upgraded separately with DMS. The sink at specific gravity (SG) 2.8 for the 0.5-2.0 mm fraction and the sink at SG 2.7 for the 0.15-0.5 mm fraction are recovered as part of the concentrate. The float is disposed as gangue. The sinks from both fractions are combined with the fine fraction of <0.15 mm as the final bastnaesite concentrate for hydrometallurgical processing. The grade of the final bastnaesite concentrate for this example is 48.2% with REE recovery of 98.1%.

HCl/NaOH process: HCl leaching of REE carbonate can be carried out at the following conditions: 93° C., 3 hr, and the acid dosage is the stoichiometric amount plus the amount required for caustic residue leach. Caustic treatment of the acid leach residue (REE fluoride-REF₃) with 20% NaOH can be carried out at the following conditions: 96° C., 4 hr, with a caustic dosage of 2.4 g NaOH/g REO. Caustic residue leaching with acid leach filtrate can be carried out at the following conditions: 70° C., 1 hr for leach and 1 hr for final pH 3.0 adjustment to reduce impurities. Mixed REE carbonate precipitation can be carried out at the following conditions: feed concentration: 0.5M to 1.0M (80 to 160 g/L REO); precipitation temperature: 50 to 60° C.; ammonium bicarbonate concentration: 15% (saturated); precipitation duration: until there are no bubbles; ammonium bicarbonate consumption is from 1.4 to 1.5 ton/t REO; maintain temperature and stirring for 30 min after completion of ammonium bicarbonate addition; filter/wash the product. For example, a 400 g sample of the final concentrate processed at the optimized conditions yields: 96.5% of REE recovered into the PLS (Pregnant Leach Solution) with very low level of impurities that meet the specifications for mixed REE carbonate precipitation. The produced mixed REE carbonate meets the standard specifications with a grade of 45.0% REO and a REE recovery of 97.0%.

Oxidation roasting/HCl leach process: This process can remove cerium at an early stage to reduce the downstream process materials by about 50%. HCl can dissolve both REO and REOF but not CeO₂ in the roasted concentrate, thus realizing cerium removal. Exemplary conditions are as follows: roasting at 500° C. for 1 hr with air flow; HCl leach of the roasted concentrate at 70° C. for 2 hr; mixed REE carbonate precipitation.

Oxidation roasting/H₂SO₄ leach process: This process can produce cerium oxide (CeO₂) as a polishing material and reduce the downstream process materials by about 50%. H₂SO₄ can dissolve REO including CeO₂, REF₃ and REOF in the roasted concentrate. Exemplary conditions are as follows: roasting at 500° C. for 1 hr with air flow; H₂SO₄ leach of the roasted concentrate to produce PLS at 70° C. for 2 hr with 2.5 mol/L H₂SO₄ at a solid-to-liquid ratio of 1:5. There are two options for the PLS processing: a) REE oxalate precipitation followed by calcination to produce mixed REE oxide including Ce oxide; or b) mixed REE carbonate and CeO₂ polishing material. The latter option can be carried out as follows: double salt precipitation to separate Ce as a polishing material (CeO₂) from Ce-free REE; impurity removal of Ce-free REE; mixed REE carbonate precipitation.

Example 2, overall: A 500 g roasted sample of the final concentrate is processed at the conditions outlined above for Example 2. 96.1% of REE was recovered into the PLS. A mixed REE oxide sample was prepared by REE oxalate precipitation from the PLS at an oxalic acid dosage of H₂C₂O₄.H₂O to REO ratio of 2.00, followed by calcination at 900° C. for 2 hr. The grade of the mixed REE oxide sample was 95.6% with a REE recovery of 99.2%.

It should be understood that numerous changes, modifications, and alternatives to the preceding disclosure can be made without departing from the scope of the disclosure. The preceding description, therefore, is not meant to limit the scope of the disclosure. Rather, the scope of the disclosure is to be determined only by the appended claims and their equivalents. It is also contemplated that structures and features in the present examples can be altered, rearranged, substituted, deleted, duplicated, combined, or added to each other.

The scope of the claims should not be limited by particular embodiments set forth herein, but should be construed in a manner consistent with the specification as a whole.

1. A method of processing an ore containing bastnaesite, carbonatite, or monazite, the method comprising:
(a) providing the ore; and
(b) calcination of the ore to form a calcinated material or roasting of the ore to form a roasted material.

2. The method of claim 1, wherein the ore has a particle size of less than 10 mm.

3. The method of claim 2, wherein the bastnaesite ore was previously mechanically processed to achieve the particle size of less than 10 mm.

4. The method of claim 1, wherein (b) comprises calcination at a temperature of about 250° C. to about 750° C. for about 0.25 to about 10 hours; and
wherein (b) comprises calcination in the presence of a reagent selected from the group consisting of lime, soda ash, and combinations thereof.

5. (canceled)

6. The method of claim 4, wherein the method further comprises:
(c) leaching of the calcinated material or roasted material in an aqueous solution, to dissolve a rare earth element, or oxide or salt thereof, from the calcinated material or roasted material in the aqueous solution.

7. The method of claim 6, wherein the aqueous solution comprises an organic or inorganic acid.

8. The method of claim 7, wherein the organic or inorganic acid is selected from the group consisting of HAc, H₂SO₄, HCl, HNO₃, and combinations thereof.

9. A method of separating a rare earth element, or an oxide or salt thereof, from an ore containing bastnaesite, carbonatite, or monazite, the method comprising:
(a) mechanically processing the ore to achieve a particle size of less than 10 mm;
(b) calcination of the mechanically processed ore to form a calcinated material or roasting of the mechanically processed ore to form a roasted material;
(c) leaching of the calcinated material or roasted material in an aqueous solution, to dissolve the rare earth element, or oxide or salt thereof, in the aqueous solution;
(d) solid/liquid separation to remove a solid residue from the aqueous solution and to recover a rare earth element solution; and
(e) precipitation of the rare earth element solution to isolate the rare earth element, or oxide or salt thereof.

10. The method of claim 9, wherein (b) comprises calcination at a temperature of about 250° C. to about 750° C. for about 0.25 to about 10 hours; and
wherein (b) comprises calcination in the presence of a reagent selected from the group consisting of lime, soda ash, and combinations thereof.

11. (canceled)

12. The method of claim 9, wherein (b) comprises roasting at a temperature of about 120° C. to about 500° C.

13. The method of claim 12, wherein the roasting in (b) is in the presence of acid.

14. The method of claim 13, wherein the acid is H₂SO₄.

15. The method of claim 9, wherein the aqueous solution in (c) comprises an organic or inorganic acid, wherein the acid is selected from the group consisting of HAc, H₂SO₄, HCl, HNO₃, and combinations thereof.

16. (canceled)

17. The method of claim 9, wherein the precipitation step (e) is in the presence of oxalic acid or a double salt, to precipitate the rare earth element, or oxide or salt thereof.

18. The method of claim 17, wherein the double salt is sodium double sulphate.

19. The method of claim 9, wherein the precipitation step (e) further comprises impurity removal in the presence of a reagent selected from the group consisting of lime, carbonate, an alkali, and combinations thereof, prior to precipitation of the rare earth element, or oxide or salt thereof.

20. The method of claim 9, wherein the rare earth element salt is a rare earth element carbonate.

21. The method of claim 9, wherein the rare earth element is selected from the group consisting of scandium, yttrium, lanthanum, cerium, praseodymium, neodymium, samarium, europium, gadolinium, terbium, dysprosium, holmium, erbium, thulium, ytterbium, lutetium, and combinations thereof.

22. (canceled)

23. The rare earth element, or oxide or salt thereof, produced by the method according to claim 1.

24. The rare earth element, or oxide or salt thereof, produced by the method according to claim 9.
